(19) United States
(12) Patent Application Publication
(10) Pub. No.: US 2002/0111928 A1
(43) Pub. Date: Aug. 15, 2002

(54) System for processing document production orders over computer network

(76) Inventor: Wadieh George Haddad, Petaluma, CA (US)

Correspondence Address: Todd A. Noah, Dergosits & Noah LLP, Four Embarcadero Center, Suite 1150, San Francisco, CA, 94111, US

(21) Appl. No.: 09/772,794

(22) Filed: Jan. 30, 2001

(51) Int. Cl. G06F 7/00

(52) U.S. Cl. 707/1

(57) ABSTRACT

A system for producing and distributing printed documents is described. The documents to be produced are classified into one or more document sets. The documents, and associated document processing information is then transmitted to a third party for production. The documents may then be delivered to one or more desired recipients. The documents are classified into document sets according to the document processing information, which may include production parameters, such as, format and media requirements like paper size and ink color. The document processing information can also include information relating to the recipients or production parties, such as printing, billing and delivery specifications.

### FIELD OF THE INVENTION

The present invention relates generally to a method of processing production orders for documents, and more specifically to a method for classifying documents to be produced and transmitting the document processing information to a third party for production.

### BACKGROUND OF THE INVENTION

Many types of businesses require the production and distribution of printed documents. In many industries, the complexity and volume of documents to be produced can vary greatly. For example, in the construction industry, various documents, from complex architectural drawings and electrical schematics to simple bills of materials and regular correspondence must be generated, copied, and distributed to the appropriate parties. The production and distribution of such documents represents a critical component in the efficient operation of many tasks. In many large-scale businesses, the request for the production of such documents is referred to as a “print work order.” Regardless of the type of business or job involved, the documents processed by a print work order must be efficiently produced and distributed to ensure the proper flow of information and products.

Present methods of processing print jobs typically involve collecting the documents to be reproduced, indicating the printing instructions for each collection of documents, and submitting the documents and instructions to a reproduction company. For print jobs that involve only one type of document and one corresponding print specification, present methods are usually satisfactory. However, for print jobs that involve different types of documents, or documents that require multiple processing steps, present methods of processing print work orders have significant drawbacks.

The problem with present methods of processing print jobs is that in order to process different types of documents, individualized instructions and specifications must be generated for each type of document. For jobs that comprise several different types of documents, this presents a burden in generating print work orders in an efficient manner.

A drawback of present methods of processing print jobs is that they usually provide for only one print specification for the entire print work order. This typically requires splitting a print work order into separate print jobs for each type of document, and may lead to confusion if a non-corresponding print specification is improperly applied to a document.

Another drawback is that present methods of processing print jobs typically do not provide for instructions allowing the entire print work order, or document subgroups therein, to be delivered to one or more recipients (split delivery), without having to manually specify each recipient, which documents to send, which delivery method to use per recipient, the due date, and so on.

Furthermore, current methods of processing print jobs typically do not provide any information beyond the types of files (i.e., drawing, text, graphic files, etc.) being sent. Therefore, while the print shop knows the type of file, it has no easy way of knowing important details of the production specifications, such as the printed media requirements like size, color and material.

Therefore, current methods of processing print jobs are generally unable to provide the flexibility, performance, and increased workflow required to effectively and efficiently provide the document processing functions necessary to ensure that print jobs are quickly and successfully completed.

### SUMMARY AND OBJECTS OF THE INVENTION

It is an object of embodiments of the present invention to provide an efficient method of producing and distributing printed documents.

It is a further object of embodiments of the present invention to provide a system of classifying document types to facilitate the processing of document production orders.

It is yet a further object of embodiments of the present invention to provide a method of generating and processing document production orders that includes flexible instructions that allow documents to be delivered to one or more specified parties in an efficient manner.

A method of producing and distributing printed documents is described. According to embodiments of the present invention, a method of producing and distributing printed documents comprises classifying the documents into one or more document sub-types or groups, providing document processing information, and communicating both the documents and their associated processing information to a third party for production. The documents may then be delivered to one or more desired recipients. The documents may be classified into groups or sub-types according to the document processing information, which may include production parameters, such as, format and media requirements like paper size and ink color. The document processing information can also include information relating to the recipients or production parties, such as printing, billing and delivery specifications.

Other features and advantages of the present invention will be apparent from the accompanying drawings and from detailed description that follows.

### BRIEF DESCRIPTION OF THE DRAWINGS

The present invention is illustrated by way of example and not limitation in the

FIG. 1 illustrates a computer network that includes client computers coupled to a server computer, and that is used to implement embodiments of the present invention;

FIG. 2 is a block diagram of a computer that executes one or more program routines that embody aspects of the present invention;

FIG. 3 is block diagram illustrating the main components of an exemplary project management system that incorporates embodiments of the present invention;

FIG. 4 is a block diagram illustrating the architectural structure of the document processing system, according to one embodiment of the present invention;

FIG. 5A is a block diagram illustrating the production of documents according to the document production system of FIG. 4, according to one embodiment of the present invention;

FIG. 5B is a block diagram illustrating the production of documents according to the document production system of FIG. 4, according to an alternative embodiment of the present invention;

FIG. 6A is a block diagram illustrating the production and distribution of print work orders, according to one embodiment of the present invention;

FIG. 6B is a block diagram illustrating the production and distribution of print work orders, according to an alternate embodiment of the present invention;

FIG. 6C is a block diagram illustrating the production and distribution of print work orders, according to a further alternative embodiment of the present invention;

FIG. 7 is a chart that illustrates the printing and plotting parameters specified for several exemplary document sets, according to one embodiment of the present invention;

FIG. 8 is a flowchart that illustrates the steps of creating a print work order according to the project management system of FIG. 3, according to one embodiment of the present invention;

FIG. 9A illustrates a graphical user interface screen for defining document sets, according to one embodiment of the present invention;

FIG. 9B illustrates a graphical user interface screen for adding or modifying document sets, according to one embodiment of the present invention;

FIG. 9C illustrates a graphical user interface screen for editing print settings for a selected document set, according to one embodiment of the present invention;

FIG. 10 illustrates a graphical user interface screen for defining recipients of a print work order, according to one embodiment of the present invention;

FIG. 11 illustrates a graphical user interface screen for selecting a reproduction company among a selection of reproduction companies, according to one embodiment of the present invention;

FIG. 12 illustrates a graphical user interface screen for entering billing information, according to one embodiment of the present invention;

FIG. 13 is a block diagram illustrating the basic components of the print work order system, according to one embodiment of the present invention;

FIG. 14 is a flow diagram that illustrates the components of the document set processing system, according to one embodiment of the present invention; and

FIG. 15 is a flow diagram that illustrates the components of the delivery company processing system, according to one embodiment of the present invention.

### DESCRIPTION OF THE PREFERRED EMBODIMENTS

A system for processing production orders for documents in an on-line project management system used by a plurality of cooperating entities is described. In the following description, for purposes of explanation, numerous specific details are set forth in order to provide an understanding of the present invention. It will be evident, however, to those of ordinary skill in the art that the present invention may be practiced without the specific details. In other instances, well-known structures and devices are shown in block diagram form to facilitate explanation. The description of preferred embodiments is not intended to limit the scope of the claims appended hereto.

Hardware Overview

Aspects of the present invention may be implemented on one or more computers executing software instructions. According to one embodiment of the present invention, a server computer system transmits and receives data over a computer network or standard telephone line. The steps of accessing, downloading, and manipulating the data, as well as other aspects of the present invention are implemented by a central processing unit (CPU) in the server computer executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server computer from a storage device, or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers.

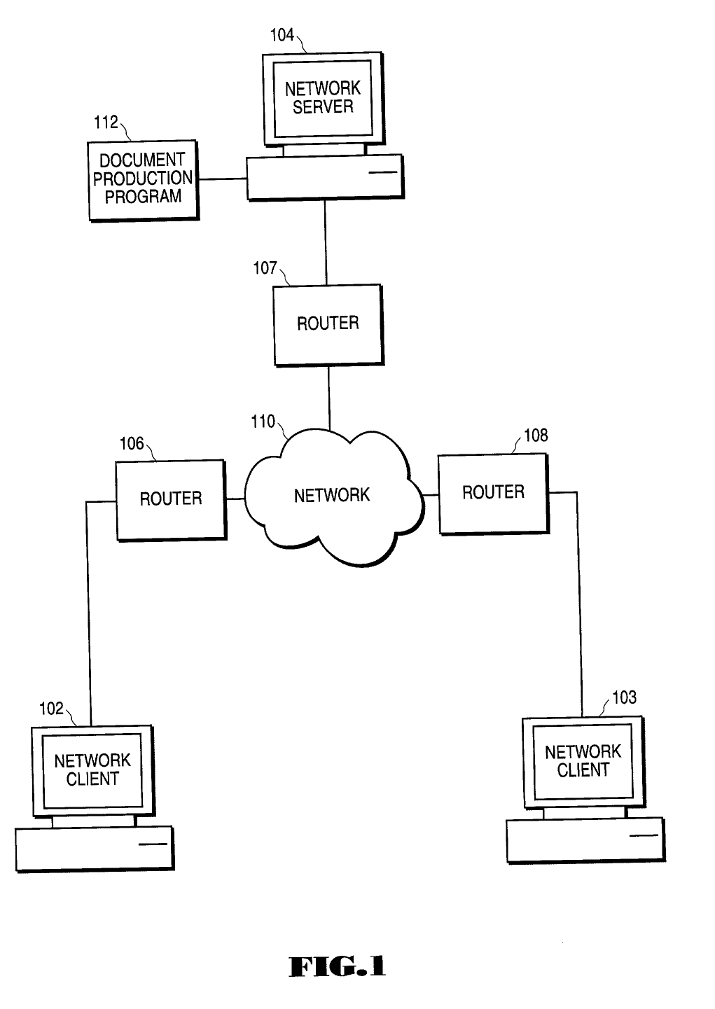

FIG. 1 illustrates a computer network system 100 that implements one or more embodiments of the present invention. In system 100, a network server computer 104 is coupled, directly or indirectly, to one or more network client computers 102 and 103 through a network 110. The network interface between server computer 104 and client computer 102 may also include one or more routers, such as routers 106, 107, and 108. The routers serve to buffer and route the data transmitted between the server and client computers. Network 110 may be the Internet, a Wide Area Network (WAN), a Local Area Network (LAN), or any combination thereof.

In one embodiment of the present invention, the server computer 104 is a WorldWide Web (WWW) server that stores data in the form of ‘web pages’ and transmits these pages as Hypertext Markup Language (HTML) files over the Internet network 110 to one or more of the client computers 102 and 103. For this embodiment, the client computers 102 and 103 typically run a “web browser” program to access the web pages served by server computer 104.

In one embodiment of the present invention, server 104 in network system 100 is a server that executes a document production program or process 112. Document production program 112 transmits and receives data from various other client computers, such as network clients 102 and 103, and processes the received data to process requests received over network 110. Document production program 112 may represent one or more executable program modules that are stored within network server 104 and executed locally within the server. Alternatively, however, document production program 112 may be stored on a remote storage or processing device coupled to server 104 or network 110 and accessed by server 104 to be locally executed. In a further alternative embodiment of the present invention, document production program 112 may be implemented in a plurality of different program modules, each of which may be executed by two or more distributed server computers coupled to each other, or to network 110 separately.

In one embodiment of the present invention, wherein network 110 is the Internet, network server 104 also executes a web server process (not shown to avoid obscuring the illustration) to provide HTML documents to client computers coupled to network 110. To access the HTML files provided by server 104, client computer 102 and/or 103 run a web client process (typically a web browser) that accesses and provides links to web pages available on server 104 and other Internet server sites. It should be noted that a network system 100 that implements embodiments of the present invention may include a larger number of interconnected client and server computers than shown in FIG. 1.

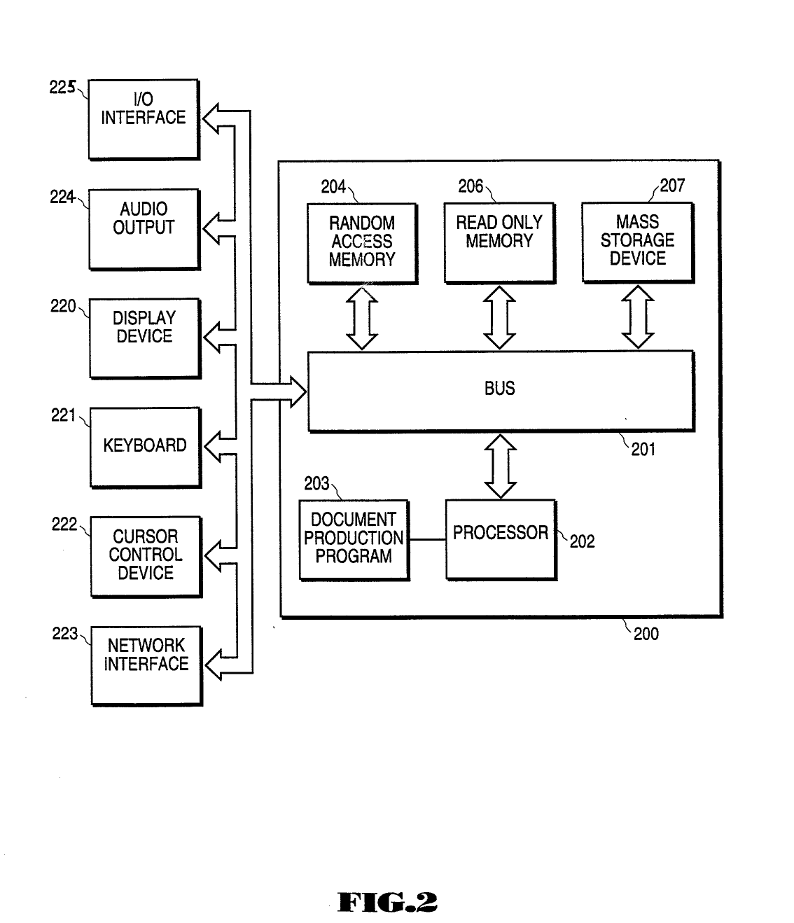

FIG. 2 is a block diagram of a representative networked computer, such as network server computer 104 illustrated in FIG. 1. The computer system 200 includes a processor 202 coupled through a bus 201 to a random access memory (RAM) 204, a read only memory (ROM) 206, and a mass storage device 207. Mass storage device 207 could be a magnetic disk, optical compact disk, or tape drive for storing data and instructions. A display device 220 for providing visual output is also coupled to processor 202 through bus 201. Keyboard 221 and cursor control unit 222 are coupled to bus 201 for communicating user commands to processor 202.

Also coupled to processor 202 through bus 201 are additional ports, such as audio output port 224, an input/output (I/O) interface 225, and a network interface device 223. Network interface device 223 provides a physical and logical connection between computer system 200 and a network. It is used by various communication applications running on computer 200 for communicating over the network medium, and may represent devices such as an Ethernet card, ISDN card, modem, or similar devices. It should be noted that the architecture of FIG. 2 is provided primarily for purposes of illustration, and that a server or client computer used in conjunction with the present invention is not limited to the specific architecture shown.

In one embodiment of the present invention, processor 202 within computer system 200 executes one or more software routines that comprise a document production program 203 that is implemented by a server computer, such as server 104 in FIG. 1.

Project and Document Management

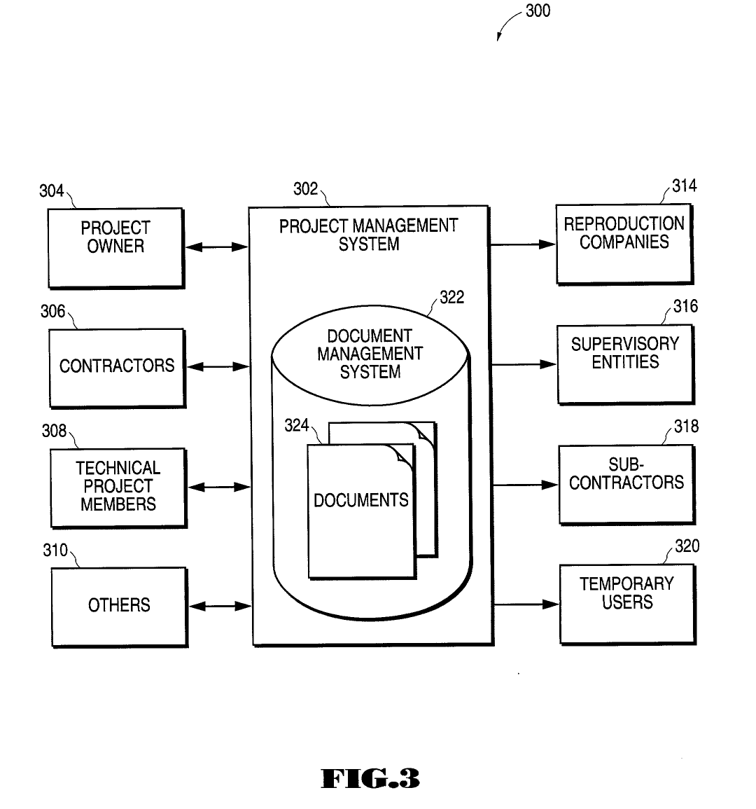

FIG. 3 is block diagram illustrating the main components of an exemplary project management system that incorporates embodiments of the document production program illustrated in FIG. 2. FIG. 3 illustrates exemplary relationships among various entities that work together on a project within a project management environment 300. In addition to showing how these entities relate to the project management system 302, FIG. 3 also illustrates some of the elements included within the project management system 302.

At the center of the project management environment 300 is a project management system 302. In one embodiment of the present invention, the project management system 302 executes one or more project management processes. In general, the project management processes represent a network of services or components that together provide adaptive, intelligent, and dynamic management of projects that involve various tasks and shared data elements and documents. More specifically, the project management processes include a document management system 322 intended for the creation, storage, modification, and distribution of various documents 324, data entities, files, programs, and other objects associated with the project management system 302.

FIG. 3 further illustrates the various entities that utilize the project management system 302 in the context of an exemplary application, such as large-scale project management in the Architecture-Engineering-Construction (AEC) industry. Such an application could be typified by a construction project involving various architectural, engineering and construction firms. In FIG. 3, the entities that may utilize project management system 302 to coordinate tasks and access shared data and documents include, contractors 306, sub-contractors 318, and technical project members 308, such as engineering consultants and architects. Other entities include, document reproduction companies 314, supervisory entities 316, such as government licensing agencies, temporary users 320, and other miscellaneous parties 310. An overall project owner 304 can also be involved. In general, the various entities all generate, modify, view, or otherwise require access data utilized by the other entities, such as documents 324. Such documents 324 could include blueprints, schedules, reports, and so on. By providing a central storage location, the document management system 322 provides a central repository for storage of files used by the different entities.

The project management system can also include a user management system, not shown, that manages the identity and privileges of the various entities that access the project management system server. For example, the user management system assigns and monitors the user privileges maintained by each of the user entities. Certain users may be assigned various privilege rights, such as the right to view only, modify, create, delete, or perform other actions on documents stored by the project management system server. The user management system verifies that desired actions are performed only by those users that have the corresponding rights to do so.

Entities with a need to access the document management system 322 may be characterized by their requirements and limitations within the project management system 302. Project owners 304, contractors 306, technical project members 308 and others 310, may require the capability to create, access and edit files, as well as the power to generate print work orders upon demand; such entities will be referred to as “Document Management System Users” (hereafter “users”) in this capacity. Reproduction companies 314, licensing agencies 316, many sub-contractors 318 as well as temporary users 320 or similar entities usually need only to have the capability of reading and/or printing the applicable documents or files. While these latter entities are not characterized as users here, embodiments of the present invention contemplate inclusion of any entity having access to the project management system 302 server, and requiring the capabilities of a user, as within the user classification.

A significant task performed by entities within project management environment 300 is the production (printing) and distribution of documents 324 required by one or more other entities within the project. The production of such documents is typically performed by the use of an order, referred to as a “print work order”, that specifies various parameters that dictate the production of the documents. For example, using the project management system 302, if a contractor 306 wanted to send a copy of a blueprint to a sub-contractor 318, the contractor would specify the blueprint within documents 324, and send the appropriate print work order to reproduction company 314 for copying and distribution to sub-contractor 318.

Print Work Order Processing Architecture

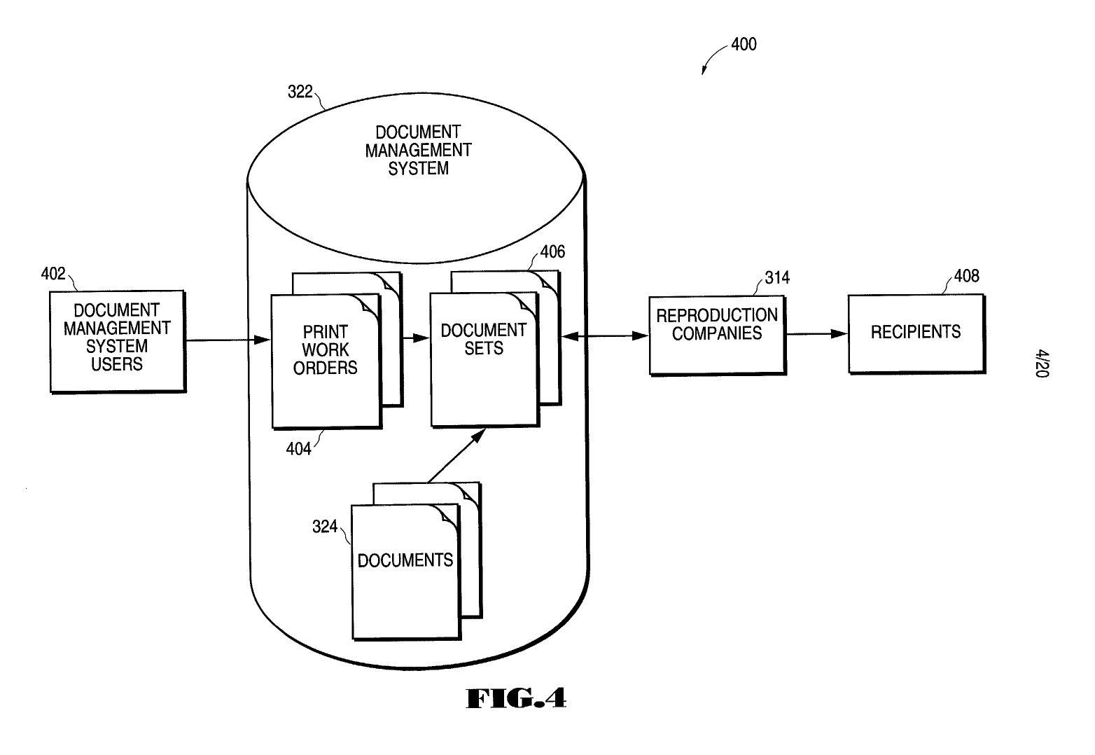

FIG. 4 illustrates the architectural structure of a document processing system, according to one embodiment of the present invention. The document processing system 400 includes users 402, the document management system 322, print work orders 404, corresponding document sets 406, reproduction companies 314, and recipients 408. Recipients 408 are usually the entities taking part in the project, but may be any entity requiring a document, or copies of a document stored in the document management system 322.

In a typical embodiment of the present invention, a print work order 404 is generated to provide diverse documents 324 to a potentially large number of recipients 408. In this role, the print work order 404 acts as a digital order form for specifying which documents are to be processed as well as any information pertaining to document processing or delivery. The information pertaining to document processing or delivery may then be used by the document management system 322 to classify the subject documents into corresponding document sets 406.

In one embodiment of the present invention, the document sets are defined to package together documents having similar printing or plotting requirements. For example, architectural drawings may require similar printing requirements, such as paper size and ink colors, whereas site drawings may require other types of printing requirements. In traditional printing processes, each of these different types of document types would require separate print work orders to handle their different requirements. The definition and use of document sets allows disparate document types to be processed using one print work order. The use of document sets also allows for more efficient communication between the user and reproduction company. The user and reproduction company may utilize pre-defined and mutually agreed upon drawing groups. In this case, the user need only associate a drawing with its respective drawing group and communicate this to the reproduction company. The reproduction company then produces the document in accordance with the parameters specified by the document set. This eliminates the need to transmit production instructions with individual documents. The reference for the appropriate drawing group need only be provided.

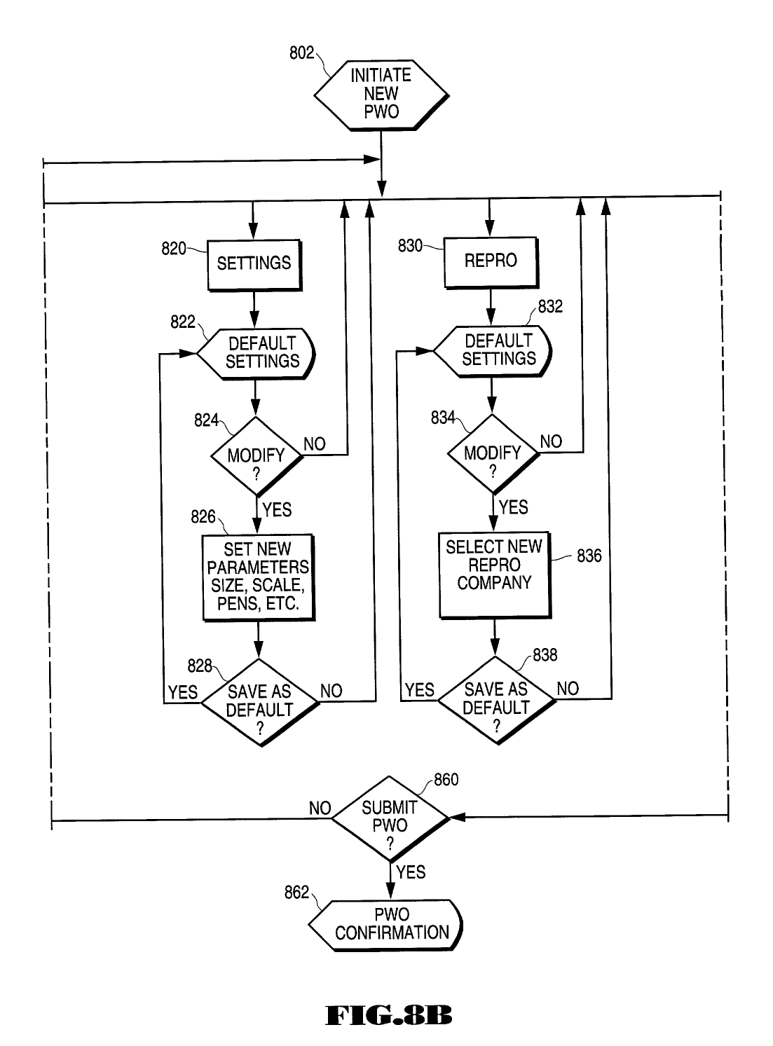

For document processing, a user 402 initiates and generates a print work order 404 according to the functionality that is explained in greater detail below. The document management system 322 classifies the documents corresponding to the particular print work order 404 into document sets 406 according to document processing information associated with the print work order 404. An exemplary embodiment of document set classification is illustrated in FIG. 7, described below. The documents 324 and document sets 406 representing the corresponding print work order 404 are then made available to the appropriate entity, such as a reproduction company 314.

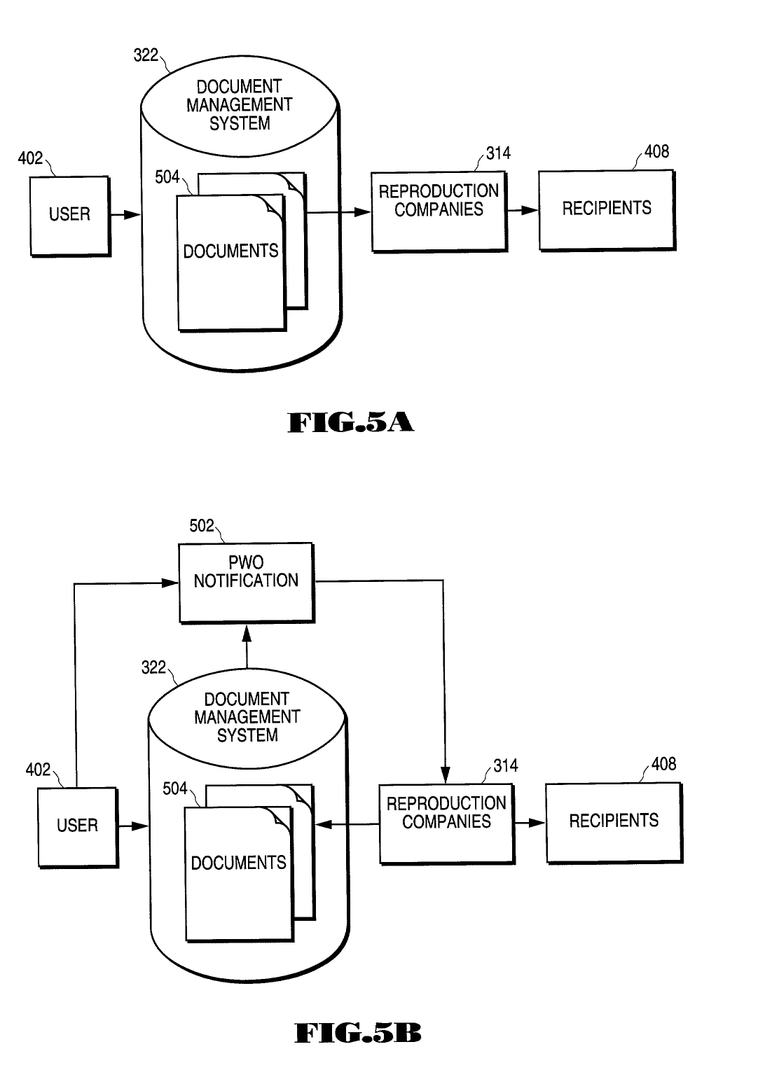

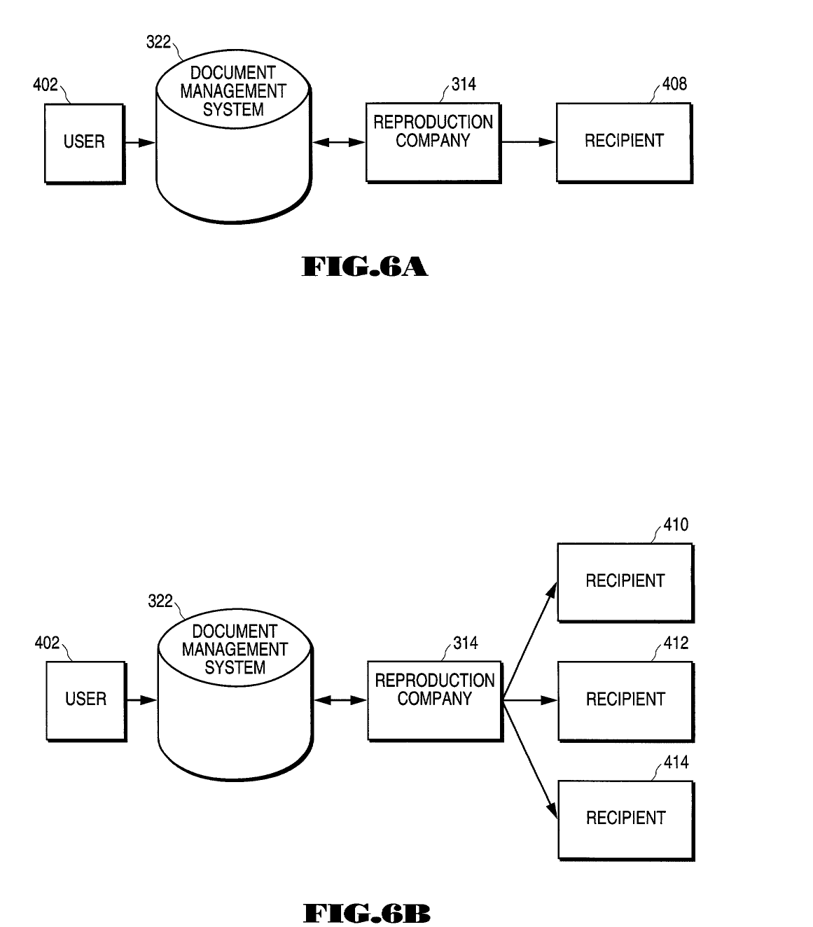

Providing the documents to be copies or produced to the reproduction companies 314 can be accomplished by several means. FIG. 5A illustrates one method of providing master documents to a reproduction company. For FIG. 5A, the document sets 406 are provided in a conventional or ‘push’ operation by active transmission of the document from the document management system 322 to the desired reproduction companies 314. For the embodiment illustrated in FIG. 5A, the user simply “sends” the document or documents 504 comprising the document set and the appropriate print work order to the reproduction company 314.

In an alternate embodiment, shown in FIG. 5B, means for providing the documents comprise a ‘pull’ operation where the reproduction company is first notified that the print work order (PWO) has been generated on the document management system 302. The notification 502 may be by email, fax, telephone, or any other similar means, and is usually generated by the document management system 302, but may be generated by the user 402 as well. The notification includes a location of the document(s) 504 to be produced. Following the notification 502, the reproduction company 314 may access the documents and document sets 406 directly from the document management system 302.

In one embodiment of the present invention, the documents to be produced and processed by a print work order are classified into appropriate document sets. Classification of the documents into their corresponding document sets allows for maximum flexibility in the production and distribution of various types of documents to one or more recipients. The use of document sets also streamlines the production process by allowing individual print work orders to cover various types of different documents. The method of classification into appropriate document sets may be selected by the document management system, the reproduction companies, or by any entity or means which produces an efficient document production process.

Print Work Order Processing Functionality

In general, a print work order specifies or refers to the document to be produced, as well as any production notes, such as number of copies, size of paper, and other requirements. Embodiments of the present invention expand the functionality of typical print work orders by including the concept of document sets to classify the documents to be produced. Thus, print work orders processed by the document management system 322 of FIG. 4 also comprises or references one or more document sets, wherein each document set contains a collection of similar document types to be processed for printing as part of the print work order. Information regarding reproduction companies, delivery and billing is stored at the print work order level, while file and document names, as well as printing specifications are stored with each document set inside the corresponding print work order.

In an exemplary embodiment of the present invention, document sets may be one of three types: large format CAD, small format b&w (black and white), or large format color and black and white. Large format CAD document sets include source applications software such as AutoCAD™, MicroStation™ and ArchiCAD™, and use file designations such as “.dwg”, “.dgn”, “p1tf”, and so on. Small format black and white document sets include source application software such as word processing programs and other desktop applications, and use corresponding file designations (e.g., “.doc”). Large format color and black and white document sets include graphic art and some desktop publishing source application software such as Adobe PhotoShop™ and QuarkXpress™, and have postscript and other large file format (e.g., CALS, TIFF, and so on).

FIG. 7 is a chart that illustrates the printing or plotting parameters required in the production of documents for these exemplary document sets. Document set chart 700 shows the definitions of these exemplary document sets in the columns corresponding to large format CAD 702, small format black and white 704, and large format color/black and white 706. Each document set has four different parameter specification fields: sheet specifications 708, additional graphic specifications 710, application specifications 712, and finishing specifications 714. These specification fields include some basic parameters which need only be selected from one of several options; these parameters and their options are shown in each of the chart entries in FIG. 7. Some parameters require a larger number of options or more detail and, in one embodiment, might be entered by a print work order author by means of a pull-down menu on a graphical user interface.

In addition to the basic parameters for large format CAD 702 shown in the corresponding column of FIG. 7, some parameters may need to be selected from a plurality of options. Within the sheet specifications field 708, options for printed size (e.g., ANSI A-8.5×11, ANSI B-11×17, Arch A-9×12, Arch C-18×24, Arch E2-26×38, ISO A3-297×420, ISO B1-707×1000, etc.), and plot scale (e.g., 1:1, 1:2, 1/10,1/50,1=1/8 inches, 1=⅔ inches, etc.) may utilize a plurality of options. Within the additional graphic specifications field 710, options for set media (e.g., bond, vellum, film, diazo blue line, diazo black, diazo paper sepia, diazo mylar, etc.) may also utilize a plurality of options.

Similarly, small format black and white 704 may also have specification parameters requiring selection from a plurality of options, according to one embodiment. Within the sheet specifications field 708, options for printed size (e.g., 8.5×11, 11×17, A4, etc.) may utilize a plurality of options. Within the applications specifications field 712, options for software (e.g., PrintFile-Postscript, Adobe Acrobat™, Pagemaker™, Quark Xpress™, Corel Draw™, Microsoft™ applications, WordPerfect™ etc.) may also utilize a plurality of options.

Large format color/black and white 706 may also have specification parameters requiring selection from a plurality of options, according to one embodiment. Printed size options within the sheet specifications field 708 may be similar to those for large format CAD described above, while software options within the applications specifications field may be similar to those for small format black and white described above.

Throughout the parameter specification fields for all three of these exemplary document sets, various parameters may also require individualized instructions to be passed along to the reproduction companies or other such entities Such parameter fields may be realized in the graphical user interface setting by means of a text box entry which provides anyone involved in document processing written instructions. In one embodiment of the present invention, text box entries may be used for ‘notes’ or ‘other’ fields, as well as for pen settings, although pen settings can conceivably be implemented by a pull-down menu as well.

FIG. 7 illustrates document set specifications for three exemplary document sets. It should be noted that various other parameters could be included, depending upon the processing requirements of the documents to be produced. Moreover, many other document types, other than those illustrated in FIG. 7 could be implemented.

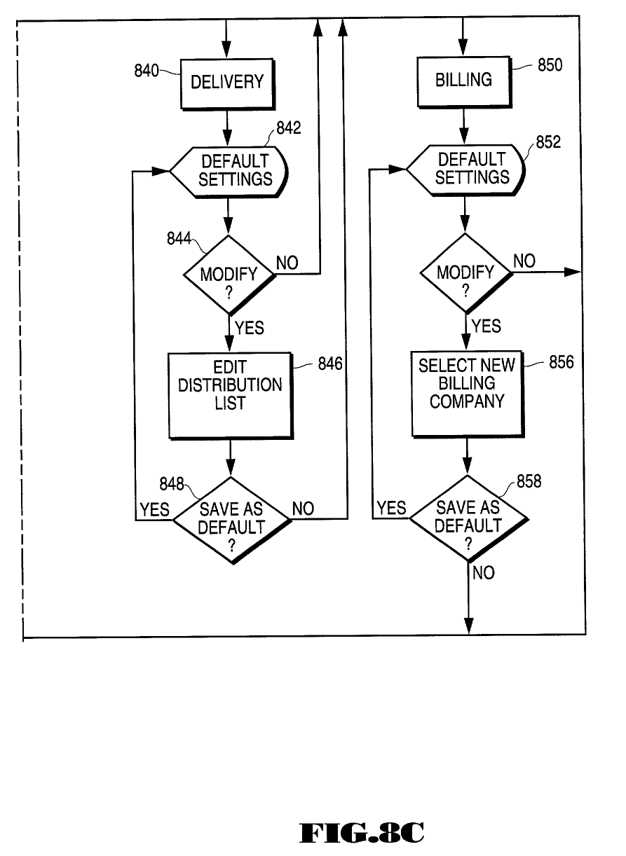

FIG. 8 is a flowchart that illustrates the steps of creating a print work order, according to one embodiment of the present invention. In step 802 the user executes a command to create a new print work order. This initiates the beginning of an input process grouped into six main print work order functions: document set options 804, file options 812, printing/plotting setting options 820, reproduction company options 830, delivery options 840, and billing options 850. For the embodiment of the present invention utilizing an Internet network, these functions may be addressed by means of a graphical user interface such as one provided through a web browser program.

In one embodiment of the present invention, the six main print work order functions may be arranged in a sequential fashion, requiring a user to go through each function before submitting a print work order. In an alternate embodiment, these functions are arranged in a parallel fashion each with default settings, allowing a user to submit a print work order upon completion of any function. For example, after files have been specified, step 812, a user can go directly to the submit print work order step 860, without having to proceed through the remaining processes.

In one embodiment of the present invention, selection of document set options, step 804, allows a user to view document sets, retrieve pre-saved document sets, step 806, and to create one or more new document sets within print work order, steps 808 and 810. Here, by default, new print work orders are comprised of one or more of the existing or predefined document set types, such as one of the three illustrated in FIG. 7. Pre-saved document sets can also be retrieved and added to the print work order using an add function. When pre-saved document sets are used, the original version of the files in the document set will be used by default. Document sets are user-definable, and new ones can be created and named just as with other similar software applications. The document set type is used to determine many of the following print work order details, such as which parameters to enter within the printing or plotting options.

The user may have the ability to select one document set and copy it with a different name. The copy process will create an identical document set that has the same properties as the source document set including the type, files attached and the corresponding printing or plotting specifications. The document set name, however, has to be unique for each print work order.

Once the user has established the document set type, the user can specify the file options, step 812. Within the file options, in one embodiment of the present invention, the user can select one or more of the project document files and add them to the document sets of the print work order, step 814. The user can save the document set, step 816, if desired. If a pre-saved document set is selected, step 818, the system will automatically retrieve the files pre-saved in the document set along with the corresponding printing or plotting specifications.

In one embodiment of the present invention, the original author of the document group is the only user who can retrieve and edit both files and printing or plotting specifications saved in the document group. Other users, when retrieving a pre-saved document set created by another, can only retrieve printing or plotting specifications for that document set without retrieving the actual files. This feature is done as a security measure to prevent any problems associated with improper file access/manipulation by a user who does not have the necessary permission. When a pre-saved document set is used, the same file version(s) originally specified in the document set will be used, unless the user specifies to update with the latest version. Users can always replace, remove or add additional files to a document set.

The different printing or plotting settings may be indicated or modified through selection of the settings options, step 820. Default settings, step 822, are applied unless otherwise specified. If a user chooses to modify the default settings, step 824, the user will then have to select the new printing or plotting settings, step 826. In one embodiment of the present invention, users can either select to apply the settings to the entire print work order or highlight individual document sets within the print work order and specify the printing/plotting settings for each set.

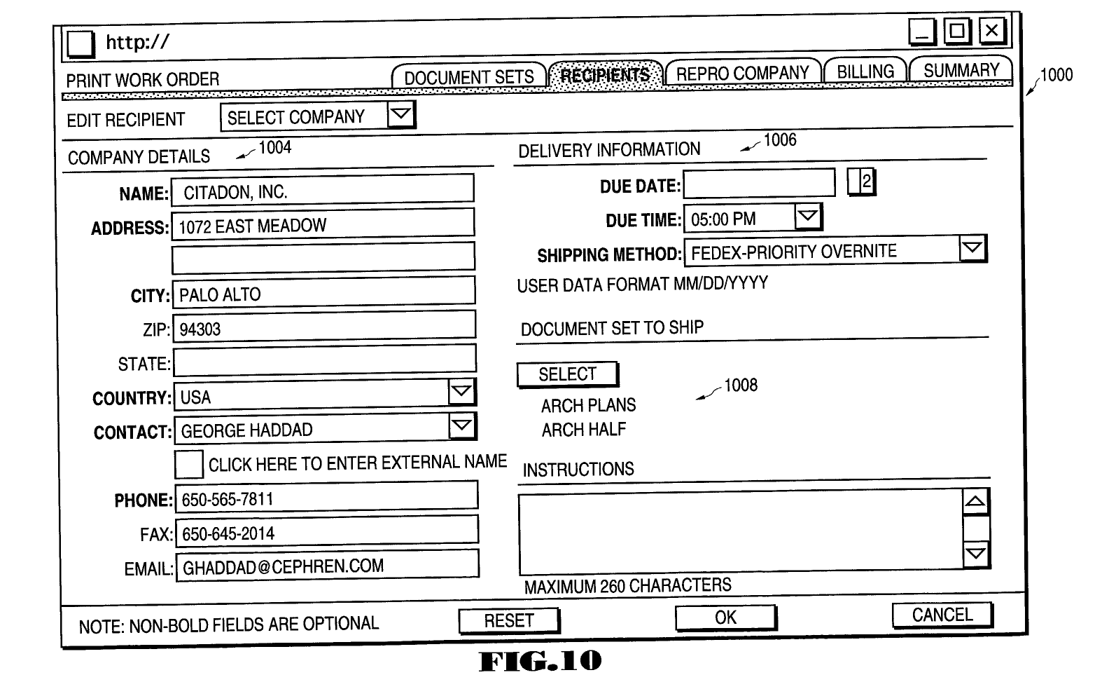

In step 828, users will also be able to save the printing or plotting settings with the document sets so as to use the same settings in the future. This is ideal when a person other than the original creator of the document set is trying to replicate the same printing or plotting specifications for a set of documents. These settings will be stored as part of the user'profile for the project within the project management system. FIG. 10 shows the graphical user interface corresponding to the printing/plotting parameter fields of the settings options function, according to one embodiment of the invention.

Options regarding the reproduction company is one of the six main functions in creating a print work order, according to the embodiment illustrated in FIG. 8. A user may select one or more reproduction companies to submit the print work order to, step 830. A reproduction company default may exist, step 832. The user may modify this default, step 834, by. Selecting new reproduction companies to be used, step 836. This default setting will be stored as part of the user'profile for the project, step 838.

The selection of delivery options, step 840, is also one of the six main print work order functions according to one embodiment of the present invention. Once delivery options are selected, the system provides delivery default settings for the appropriate user or document set, step 842. In step 844, the user has the choice to apply these default settings, which completes the delivery function, and proceed forward with the print work order. Alternately, at step 844, the user may modify the delivery default settings, thereby giving the user the opportunity to select one or more recipient companies from a distribution list. The user selects the company from the list and the delivery details for the selected company are displayed on a delivery details screen. If multiple reproduction companies have been assigned to the print work order and multiple recipients are requested, the user will be able to highlight each reproduction company and select the desired recipient company.

When delivery selections have been changed, users will be able to edit or add entries on the distribution list, step 846, in one embodiment. Users will also be able to save a delivery specification as the default setting, step 848, for ease in creating repetitive print work orders. In one embodiment, the document management system provides the date and time due information along with the delivery selections. Additionally, the system will prevent submission of the same print work order to the same recipient company by more than one reproduction company. This is to prevent the same job from being processed by multiple reproduction companies and sent to the same recipient.

The selection of billing options, step 850, is the last of the six main print work order functions according to the embodiment of the present invention illustrated in FIG. 8. Once the billing options function is selected, the document management system provides billing default settings for the appropriate user or print work order, step 852. In step 854, the user has the option to apply these default settings, which completes the billing function, and proceed forward with the print work order. Alternately at step 854, the user may modify the billing default settings. The user then has the opportunity to select a project company member to be billed, step 856. In one embodiment, the user has the ability to save their selection as a default, step 858, which will be stored in the user' profile for the project. An input field requesting an account number to be billed may also be present.

Once the six main print work order functions are modified or left at default, the print work order is ready to be submitted. If any changes need to be made at this point, the user will be given the option to go back to the print work order main function interface for editing of the desired section of the order. If the print work order is satisfactory, the user then submits the print work order to the document management system, step 860. In one embodiment of the present invention, the document management system then notifies the selected reproduction companies. As a final step, 862, a print work order confirmation will be displayed informing the user that the transaction was completed successfully.

Computer Implementation

Within the project management environment 300 illustrated in FIG. 3, in one embodiment of the present invention, the project management system 302 may include one or more computer software programs that are distributed over a server computer. Such a server can be embodied within a networked computer server, such as server 104 in FIG. 1, providing an on-line project management system.

The components and sub-components of the on-line project management system 302 may reside on different server and/or client computers in a distributed or networked computer system Various embodiments of the present invention may be on-line implementations that utilizes the Internet network and various Internet-specific technologies. However, it should be noted that alternative embodiments of the present invention may utilize other types of network technologies. For example, the networks coupling the project management system server process to the various user clients may be implemented as any type of computer network, such as a private LAN (local area network), WAN (wide area network), intranet, or any combination thereof that connects two or more computers together.

Likewise, for the embodiment of the present invention in which the network utilized is the Internet, the document production processes are typically implemented through user interface programs that utilize web server and web browser programs. Alternatively, however, these document production processes can be implemented as proprietary or dedicated software programs that communicate over a public or private computer network that couples the on-line project management system to the users.

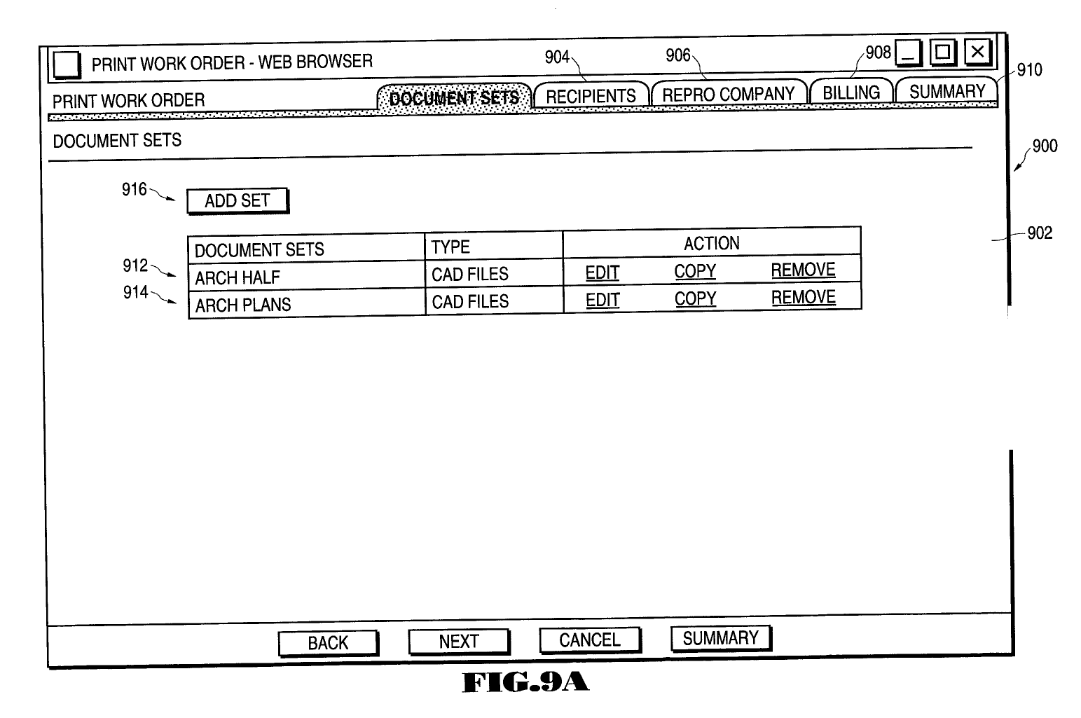

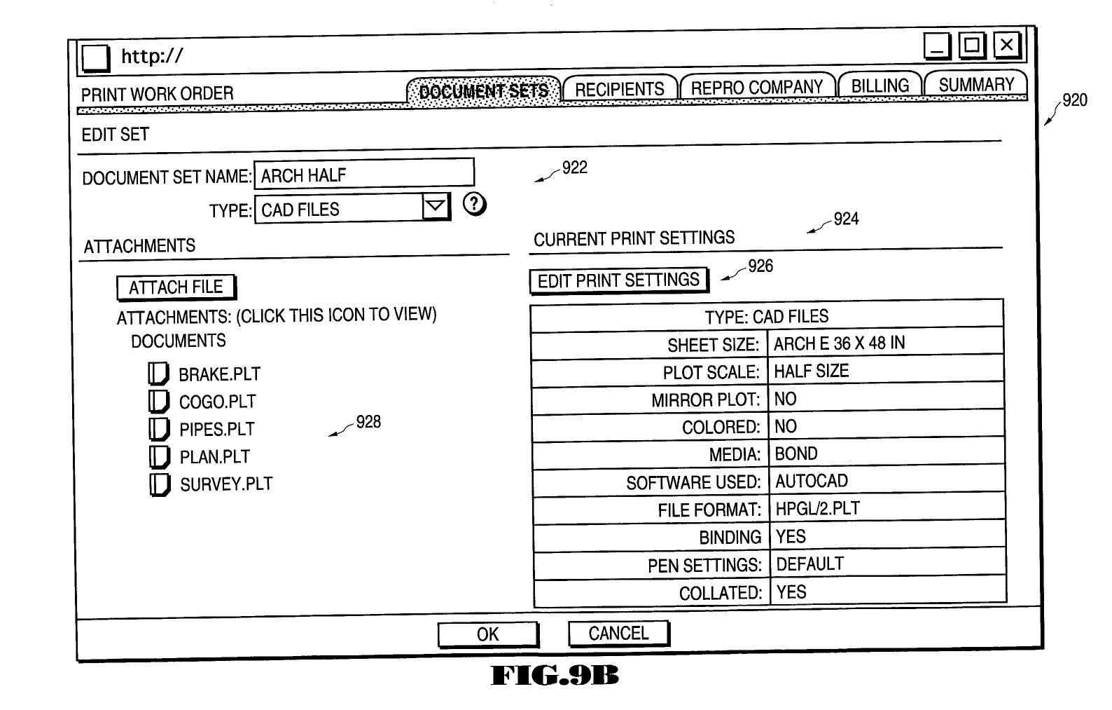

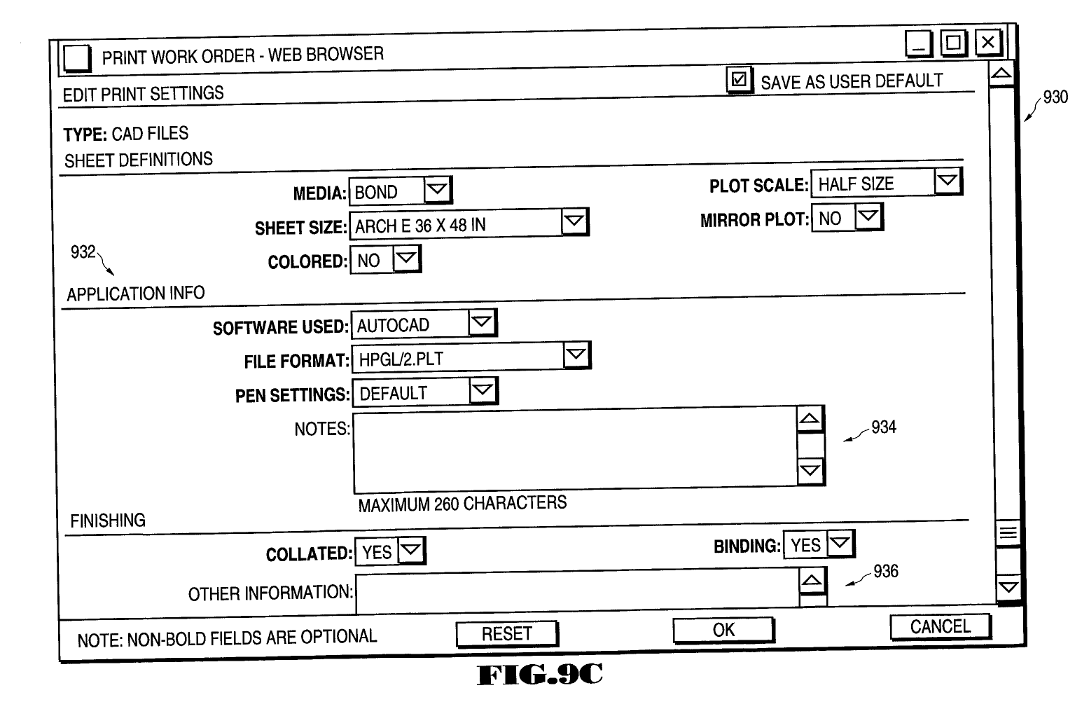

In the exemplary embodiments mentioned above, the creation of a print work order may be accomplished by a system of graphical user interfaces representing the main print work order functions. FIG. 9A illustrates a graphical user interface screen for adding or modifying document sets to a print work order, according to one embodiment of the present invention. User interface 900 illustrates the display screen for the document set interface screen 902. The other main function screens are accessed by selecting the appropriate interface tab: 904 for the recipients screen, 906 for the repro company screen, 908 for the billing screen, and 910 for a print work order summary screen.

The document set screen 902 lists the document sets defined for a particular print work order. Multiple document sets may be included in a single work order, and are listed by name and type in the document set interface window 902. The examples illustrated in FIG. 9A include, architectural half drawings (“arch half”) 912, and architectural plans (“arch plans”) 914. Both document sets are shown as CAD files. Existing document sets can be removed, edited, or copied through option buttons displayed on document screen 902. A user input function to add document sets 916 to a print work order is also provided in the document set screen 902. The add option button 916 provides access to a database or directory of documents accessible to the document production program to allow the definition of additional document sets.

At the bottom of the document set interface screen 902, the user has the options to save the print work order he or she is working on, go back to the previous interface screen, cancel the current interface selection, or go to the next interface screen. At any time a cancel selection is made here or at other times during print work order creation, the user may elect to save the subject print work order as a draft.

FIG. 9B illustrates a graphical user interface screen showing input and display information for the editing document sets, according to one embodiment of the present invention. For the document set editing interface screen 920 is displayed when the “edit” function of a document set is selected. For the example illustrated in FIG. 9B, the document set “arch half” 912 edit function was selected. In the editing interface screen 920, the document set name and document type are defined in display fields 922. The print settings for this document set are provided in the current print settings field 924. One or more files may be attached to the document set. The attached files are illustrated in the attachment display field 928.

The print settings for the document set are illustrated in field 924. These settings may be modified by the selection of the edit settings option button 926. FIG. 9C illustrates a graphical user interface screen for editing print settings for a selected document set, according to one embodiment of the present invention. Various printing and production options can be specified within the editing interface screen 930. Parameters related to the print media are entered by the user in the sheet definition fields 932. Parameters relating to the document format, pen settings, and file format of the documents are specified in the application information fields 934, and parameters relating to final production of the document set is entered in finishing field 936.

The document production process includes corresponding graphical user interface screens for the other main processes accessible through the print work order interface screen 900, namely, recipient selection 904, repro company selection 906, and billing 908. FIG. 10 illustrates a graphical user interface screen for defining recipients of a print work order, according to one embodiment of the present invention. The recipient interface screen displays the recipients selected by the user to receive the print work order once it is produced. One or more recipients may be specified. As illustrated in FIG. 10, the recipient interface screen includes a recipient editing feature 1002 that allows the user to enter recipient information, such as name, address, contact information, and so on in a “company details” input field area 1004. The edit recipient function also includes a delivery information input field area 1006 that allows the specification of delivery methods. The document sets that are to be delivered to the recipient are specified in the “document sets to ship” input field area 1008.

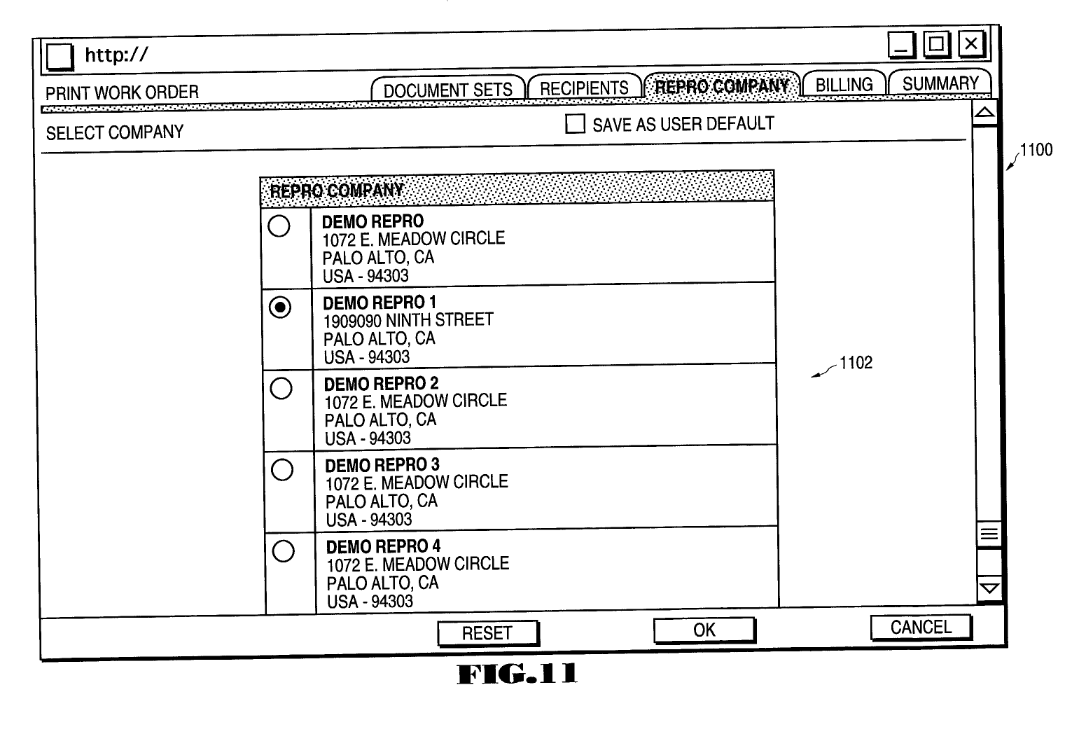

In one embodiment of the present invention, the document sets to be delivered to the specified recipients are produced by one or more repro companies. These repro companies can be third party professional printing or reproduction service companies. Contact information for the repro companies that are available to produce print work orders are provided in a repro company selection interface screen accessed by tab 906 in FIG. 9A. FIG. 11 illustrates a graphical user interface screen 1100 for selecting a reproduction company among a selection of reproduction companies, according to one embodiment of the present invention. As illustrated in FIG. 11, a number of repro companies are listed in a repro company list field area 1102. One or more repro companies can be selected to produce the print work order. The information pertaining to the available repro companies can be modified or added through an editing feature similar to that provided for the recipients, as illustrated in FIG. 10.

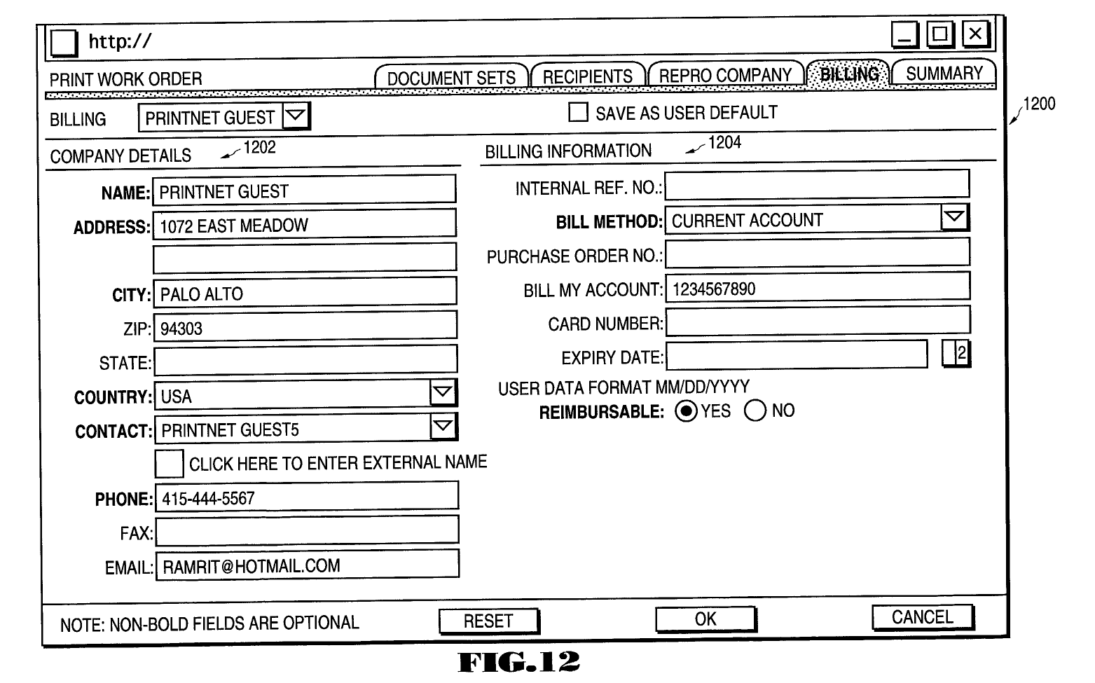

FIG. 12 illustrates a graphical user interface screen for entering billing information, according to one embodiment of the present invention. The billing information interface screen is similar to the recipient identification interface screen illustrated in FIG. 10. In billing interface screen 1200, a company detail information field area 1202 is illustrated along with a billing information field area 1204. The billing information includes credit line or credit card information, and other payment related information.

In one embodiment of the present invention, a print work order summary screen may be included, displaying all of the print work order details for reviewing purposes. If any changes need to be made at this point, a back button will take the user back to the print work order tab interface for editing any section of the print work order. Once reviewed for acceptability, a submit order button may be used to send the print work order to the document management system and notify the selected reproduction companies. A confirmation screen showing the print work order number and informing the user that the order was successful may also be included.

According to one embodiment of the present invention, another function included is a print work order reporting tool giving the project administrator various supervisory capabilities. For example, the administrator will be able to generate print work order reports for a particular project, based on various criteria, such as, print work orders sent to a specified reproduction company, print work orders sent to all reproduction companies, a specified range of dates, or print work orders that are sent, in progress, on hold, completed or in draft format. Once the report type and dates have been selected, the result report may show the summary of the any of the following fields, such as, project number, reports date, name and company of requesting user, print work order number, sent on date, created by, due date, reproduction company, deliver to, bill to, and number of sets.

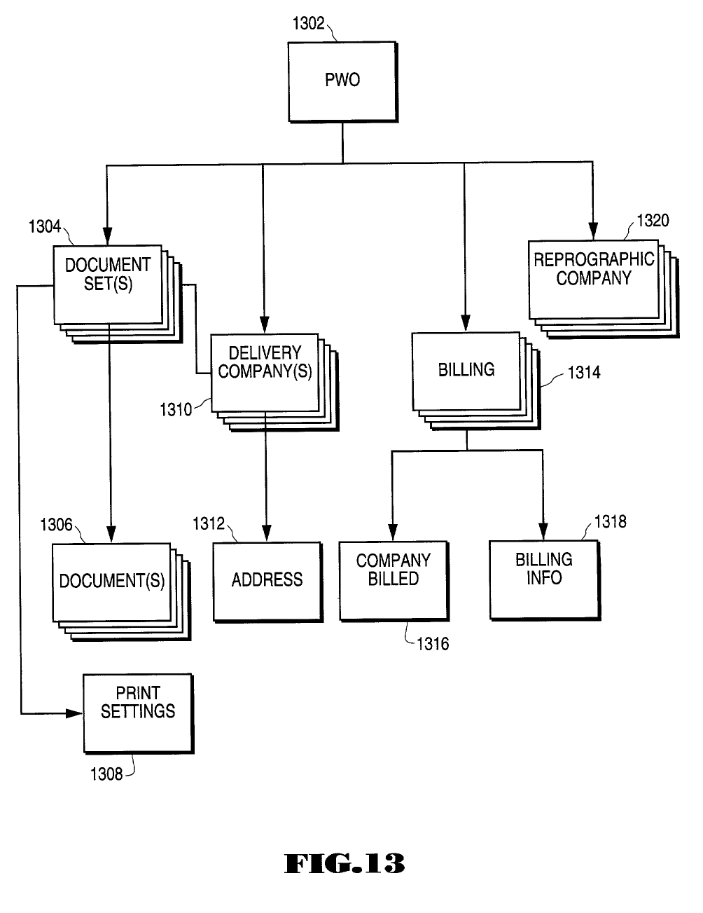

FIG. 13 is a block diagram that illustrates the functional relationships among the major functions of the print work order process as defined and processed by the user, according to one embodiment of the present invention. The print work order 1302 is defined to include one or more document sets 1304. The documents set(s) 1304 include one or more documents 1306 which are defined by various print settings 1308. The user can identify the documents and defines the corresponding print settings through the document set interface screens illustrated in FIGS. 9A, 9B, and 9C.

The print work order may be produced in-house or locally, or through a separate reprographic company. If the print work order is produced locally, it is produced and then transmitted to the appropriate delivery company 1310 for delivery to the recipient address 1312. The delivery company and recipient address information can be provided by the user through the recipient information interface screen illustrated in FIG. 10. Alternatively, the print work order may be produced externally. In this case, the documents sets are then transmitted to a reprographic company 1320 for production. The reprographic company selected to produce the print work order can be specified through the repro company selection interface screen illustrated in FIG. 11. Upon delivery of the print work order, the customer or recipient can be billed through billing process 1314. The company billed 1316 and billing 1318 information can be provided through the billing information interface screen as illustrated in FIG. 12.

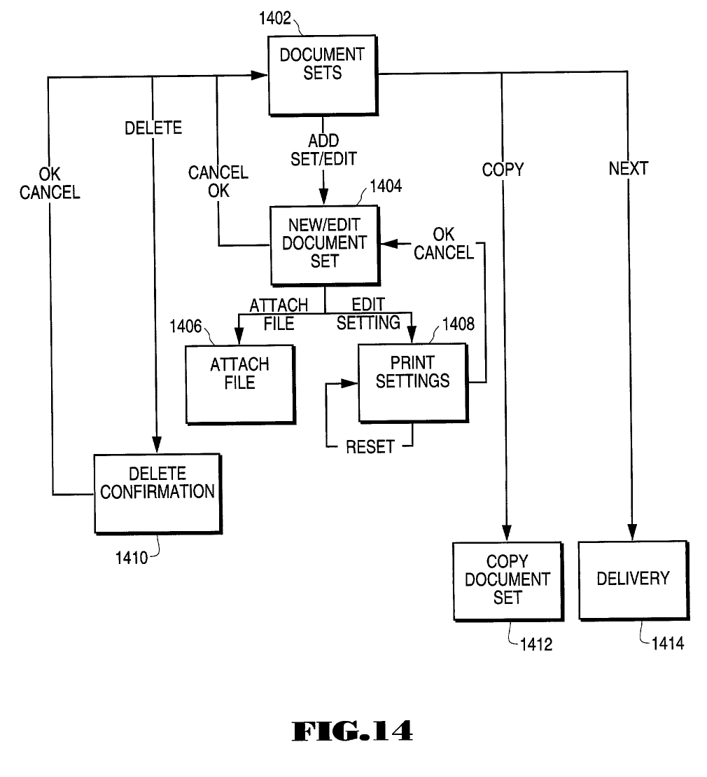

FIG. 14 is a flow diagram that illustrates definition of document sets through the user interface screens illustrated in FIGS. 9A, 9B, and 9C, according to one embodiment of the present invention. Using the commands available in the document set interface screen 900, the user can process the document set or sets to be included in a print work order. As illustrated in FIG. 14, document sets 1402 can be added or edited to create new or edited document sets 1404. Attached files 1406 may be associated with the document sets 1404 and the appropriate print settings 1408 may be defined. Existing document sets 1402 can be deleted if necessary, in which case a delete confirmation 1410 is generated. Existing document sets may be copied through a copy document set function 1412. Once the document set or sets for a work order are properly defined, they are processed through a delivery process 1414.

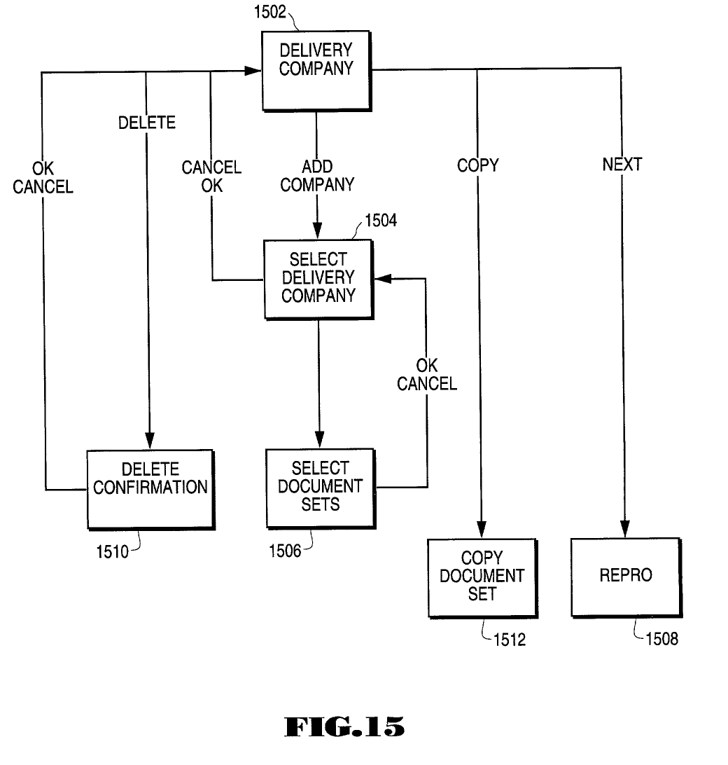

FIG. 15 is a flow diagram that illustrates the processing of a print work order through a delivery company process 1502 as accessed by the user through the user interface screen illustrated in FIG. 10. A delivery company can be selected through a delivery company selection process 1504. Existing delivery companies 1502 can be deleted if necessary, in which case a delete confirmation 1510 is generated. Once the delivery company is selected, the document sets to be delivered 1506 are selected. Through the delivery company interface screen, existing document sets may be copied through a copy document set function 1512. If the print work order is to be produced by a third party reprographic company, the appropriate repro company 1508 is selected through the repro company selection interface screen, as illustrated in FIG. 11.

As illustrated in FIGS. 5A and 5B, the document management system essentially acts as a processing interface between users 402 and recipients 408 for documents produced by reproduction companies 314. The document management system 302 may be used in various scenarios involving any number of reproduction companies and recipients.

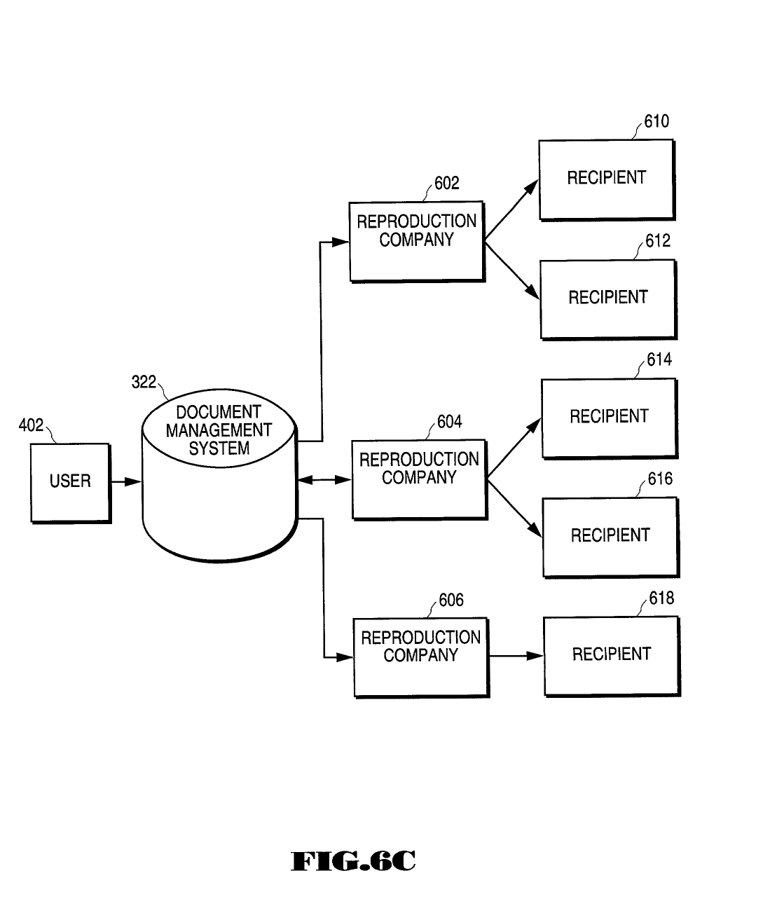

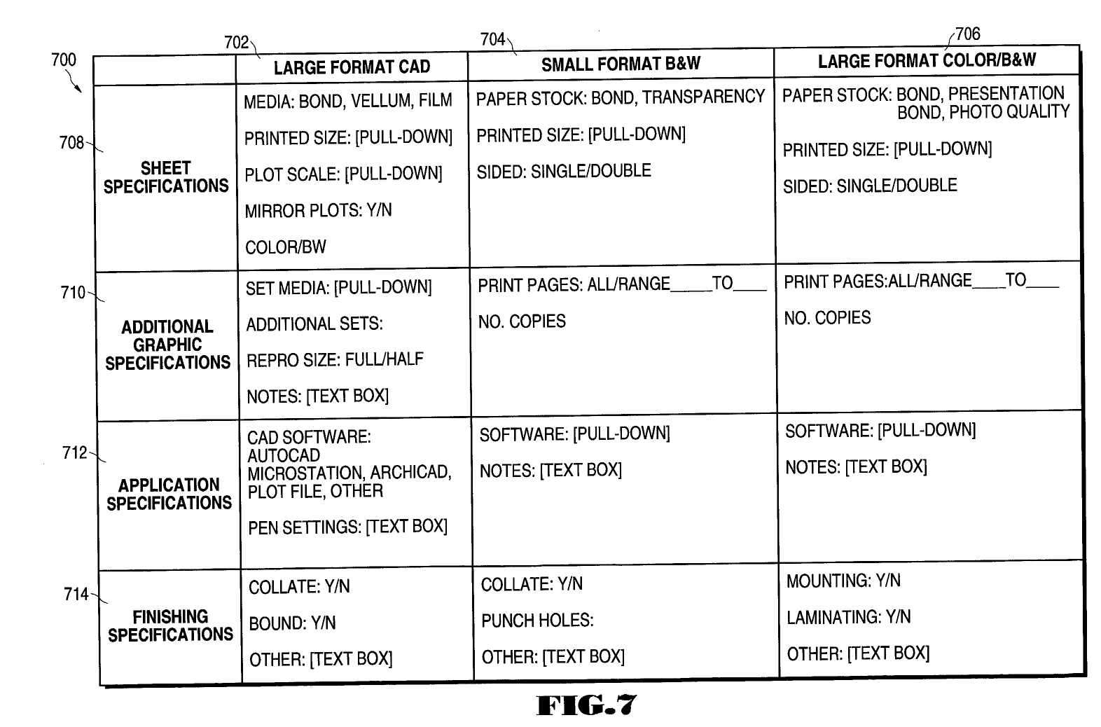

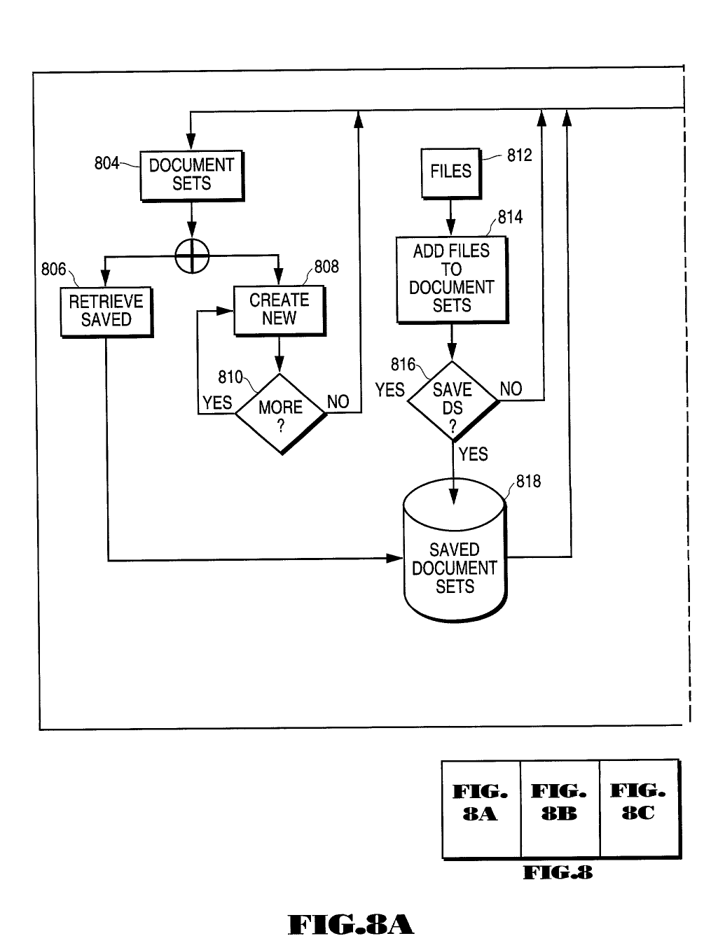

FIG. 6A illustrates a scenario in which one or more print work orders are generated by a user on the document management system 322 for processing at a single reproduction company 314 and delivery to a single recipient 408. Even at this simple level, a more efficient process may be obtained by having the document sets classified according to their printing machine capabilities or requirements of the reproduction company 314.

FIG. 6B illustrates an alternate embodiment of the present invention, in which one or more print work orders are generated by a user 402 on the document management system 322 intended for processing at a single reproduction company 314 and delivery to multiple recipients 410-414. Each recipient may receive anything from one document or document set to multiple sets of all documents in the print work order, as required. Very efficient document production may be provided in this embodiment when each recipients requires document within only one document set, as is often the case.

A second alternate print work order distribution scenario is shown in FIG. 6C, in which one or more print work orders are generated by a user 402 for processing at multiple reproduction companies 602, 604, and 606. For this scenario, each of the reproduction companies distributes the documents to multiple recipients 610-618. Again, each recipient may receive anything from one document or document set to all documents in the print work order, as required. Selection of a document set classification technique here may be done by any means that maximizes the document production efficiency.

For the embodiments illustrated in FIGS. 4-6, the print work orders are made available to reproduction companies for subsequent delivery of documents to their intended recipients. However, embodiments of the present invention also allow for making print work orders, document sets or appropriate documents directly available to intended recipients who have access to the project management system. This allows for more effective document distribution to recipients who, for example, are capable of directly printing or plotting the documents they need.

In the foregoing, a system has been described for processing print work orders by defining and associating documents into appropriate document sets. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of processing production orders for documents comprising the steps of:
determining document processing information for each type of document to be produced;
classifying documents to be produced into one or more classification groups according to specifications regarding production of the respective documents; and
providing the documents and their respective classification groups to one or more parties for production.

2. The method of claim 1 wherein the production order is a print order.

3. The method of claim 2 wherein the production specifications are selected from the group consisting of printing specifications, binding specifications, billing specifications, and delivery specifications.

4. The method of claim 3 wherein the production specifications are printing specifications.

5. The method of claim 1 further comprising the step of causing the documents to be delivered to respective recipients by the one or more parties.

6. The method of claim 5 wherein the one or more parties are reproduction companies.

7. The method of claim 1 wherein the method is carried out by a document management system on a computer network.

8. A method of classifying documents to be produced comprising the steps of:
receiving one or more documents from a first party to be produced by a second party;
determining one or more production specifications controlling production of a respective document to define one or more product classification groups; and
assigning the one or more documents to a respective production classification group.

9. The method of claim 8 wherein the production specifications are selected from the group consisting of printing specifications, binding specifications, billing specifications, and delivery specifications.

10. The method of claim 9 wherein the production specifications are printing specifications.

11. The method of claim 8 wherein the second party is a reproduction company.

12. A system for producing and distributing documents of a printed nature, the system comprising:
a first computer, wherein the first computer is maintained by a user who intends to print the documents;
a production order to be communicated to the first computer; and
a database accessible to the first computer and configured to both store the documents and classify them according to document processing specifications, wherein the document processing specifications for each type of document are integral with the print work order.

13. The system of claim 12 wherein the production order is comprised of document sets determined by the document processing specifications, whereby the document sets are selected to facilitate document printing requirements of the user.

14. The system of claim 13 wherein the document processing specifications are selected from the group consisting of printing specifications, binding specifications, billing specifications, and delivery specifications.

15. The system of claim 14 wherein the production specifications are printing specifications.

16. The system of claim 12 wherein the production order is a print order.

17. The system of claim 12 wherein the system is implemented over a computer network.
